(19) United States
(12) Patent Application Publication
(10) Pub. No.: US 2012/0063734 A1
(43) Pub. Date: Mar. 15, 2012

(54) MULTIMODE GRADED-INDEX PLASTIC OPTICAL FIBER AND METHOD FOR PRODUCING THE SAME

(76) Inventor: Yasuhiro KOIKE, Yokohama-shi (JP)

(21) Appl. No.: 12/878,577

(22) Filed: Sep. 9, 2010

(51) Int. Cl. G02B 6/028

(52) U.S. Cl. 385/124; 427/163.2

(57) ABSTRACT

A multimode graded-index plastic optical fiber comprises a cladding and a core. The core has a refractive index which continuously becomes higher as closer to a center of a circular cross-section of the core. The core propagates light of a first mode group, which should be propagated, of incoming light from one end face of the core and emits the light from the other end face of the core. The cladding is provided on a periphery of the core and has a cylindrical cross-section. The cladding has a refractive index which is lower than that of the core. The cladding deflects light of the first mode group at an interface with the core. The core has a first core section, a second core section and a third core section. The first core section contacts an inner circumference of the cladding. The second core section is inside the first core section, and is inside the core. The second core section is a light scattering section which scatters light of a second mode group of the incoming light outside. The second mode group is of a higher order than the first mode group.

### BACKGROUND OF THE INVENTION

1. Field of the Invention

The present invention is related to a multimode graded-index plastic optical fiber and a method for producing the same.

2. Description of the Related Arts

For an optical fiber widely used as an optical transmission medium, various organic polymers are used instead of inorganic materials, for purposes of weight saving and giving flexibility. In the optical fibers, a graded-index (GI) optical fiber is widely used. The GI optical fiber has a refractive index continuously varying in a certain direction.

Accordingly, the GI optical fiber guides a light entered within a predetermined angle in the longitudinal direction of the optical fiber. When the refractive index continuously varies in a certain direction, it means that a refractive index profile is continuous in the certain direction. To develop such the continuous refractive index profile in the optical fiber, various producing methods are proposed.

A GI type, in plastic optical fibers (POF) where its core and cladding are formed of a polymer material, can be roughly categorized into two types from a perspective of producing method. One is a optical fiber of dopant type, and the other is a optical fiber of copolymer type.

The plastic optical fiber of dopant type is a plastic optical fiber whose core covered by a cladding has a gradient of concentration of low molecular weight material against a polymer for a matrix in a radial direction of a circular cross-section. The refractive index profile is developed by this concentration gradient. As producing methods for such the dopant type plastic optical fibers, for example there is a method disclosed in Japanese Patent No. 3332922 (U.S. Pat. No. 5,541,247), where a polymer for a matrix and an unreactive low molecular weight material are mixed to diffuse the low molecular weight material in the polymer, so as to give a concentration gradient of the low molecular weight material. Unreactive means that not to react with the polymer for the matrix, and low molecular weight means that the molecular weight is no more than 2000. As the low molecular weight material, a material having higher refractive index than that of the polymer, and the low molecular weight material is sometimes called as a refractive index increasing agent (dopant).

The copolymer type plastic optical fiber is that whose core is obtained by copolymerization of two kinds of monomers different from each other, as described in Japanese Laid-open Patent Publication No. 05-173025 and Japanese Laid-open Patent Publication No. 05-173026. In forming of the core, a gradient of concentration of the monomers is given with use of a difference of reactivity ratios between the monomers. By this concentration gradient, the refractive index profile is developed.

When the plastic optical fibers of dopant type and copolymer type are compared in a perspective of transparency, generally the dopant type optical fiber is superior. The reason is that in case of the copolymer type plastic optical fiber, when the refractive index profile is formed, optical properties except the refractive index tend to be ununiform. Accordingly, as the GI plastic optical fiber, the dopant type is preferable than the copolymer type.

As a producing method for the dopant type GI plastic optical fiber, an interfacial gel polymerization method is known. In this method, a mixture liquid composed of a plurality of radical copolymerizable monomers is gradually fed into a cylindrical container which held horizontally and rotates around a central axis, and a difference of refractive indexes and a concentration difference between the monomers are controlled to be within specific ranges. According to this control, a synthetic resin optical transmission medium having a refractive index gradient which is continuous in a traveling direction of polymerization is obtained. As another producing method, there is a method proposed in Japanese Laid-open Patent Publication No. 08-336911. This method is a melt-extrusion method in which a core polymer which forms a core and includes a dopant and a cladding polymer which forms a cladding are joined in a polymer state. In this melt-extrusion method, the dopant crosses an interface between the core polymer and the cladding polymer, and diffuses into the cladding polymer.

In general, a refractive index profile of the GI optical fiber can be represented by a following formula (1):

n(r)=n₁ [1-2Δ(r/a)^{g}]^{1/2}(0≦r≦a)

n(r)=n₂ r>a (1)

wherein n(r) is a refractive index at a position apart the distance r from the center of the circular cross-section of the optical fiber in the radial direction, a is a radius of the core, Δ is a difference of relative refractive indexes between the core and the cladding, n₁ is the maximum value of the refractive index of the core, that is, the maximum refractive index, n₂ is the refractive index of the cladding, and g is a parameter which should be a reference of the refractive index profile. g is called as a profile parameter.

About a specific light wavelength, the g-value, which gives an optimum refractive index profile where a transmission capacity of the optical fiber becomes the maximum, can be calculated theoretically based on a relationship to a bandwidth. A graph of the bandwidth theoretically calculated based on the g-value is illustrated as a solid line in FIG. 4. When the bandwidth corresponding to the g-value is calculated as described above, the g-value where the bandwidth becomes the maximum value is the optimum g-value for the specific light wavelength.

As illustrated in FIG. 4 as the solid line, a transmission capacity of the optical fiber at a certain light wavelength is rapidly reduced as the g-value is coming off the optimum value. Accordingly, in production of the GI optical fiber, the refractive index profile needs to be controlled precisely.

In addition, the g-value which gives the optimum refractive index profile becomes different according to a wavelength of light to be propagated. Accordingly, when an optical fiber designed to be optimum for a certain light wavelength is used for another light wavelength, a sufficient transmission capacity cannot be insured. For example, when the optical fiber is used for a wavelength division multiplexing transmission system, a transmission capacity of the system is limited.

### SUMMARY OF THE INVENTION

An object of the present invention, which solves the above problems, is to provide a multimode graded-index plastic optical fiber which has a sufficient transmission capacity even if a g-value is out of an optimum value calculated from a theoretical value and even if the optical fiber is used for different wavelengths, and a method for producing the same.

A multimode graded-index plastic optical fiber of the present invention comprises a core, a cladding and a light scattering section. The core has a refractive index continuously becomes higher as closer to a center of a circular cross-section of the core, the core propagates light of a first mode group, which should be propagated, of incoming light from one end face of the core and emitting the light from the other end face of the core. The cladding is provided on a periphery of the core and has a cylindrical cross-section, the cladding has a refractive index which is lower than that of the core and deflects light of the first mode group at an interface with the core. The light scattering section scatters light of a second mode group of the incoming light outside, the second mode group is of a higher order than the first mode group. The light scattering section is inside the core.

It is preferable that the light scattering section has a ring cross-section, and a center of a circular cross-section of a cavity is superimposed on the center of the circular cross-section of the core.

It is preferable that a scattering loss rate calculated according to (SLN/SL0)×100 is at least 150%, under conditions that SL0 is a scattering loss of light of a mode whose order is the lowest in the first mode group, and that SLN is the maximum value of a scattering loss of light of the second mode group.

It is preferable that the light scattering section is positioned in a range of 0.50xR to 0.98xR apart from the center of the circular cross-section of the core, under a condition that a radius of the core is represented as R.

A method for producing a multimode graded-index plastic optical fiber of the present invention comprises steps of forming a first structure, diffusing and cooling. In the first structure forming step, the first structure, in which a periphery of a first member having a circular cross-section is covered by a second member, is formed. The first member includes a transparent first polymer and a dopant which is a nonpolymerizable substance having a refractive index higher than that of the first polymer. The second member includes a transparent second polymer which has a refractive index lower than that of the first polymer. In the diffusing step, the dopant is diffused by heating the first structure. The diffusion makes the first structure to a second structure. The second structure includes a cladding having a ring cross-section and consisting of a part including a periphery of the second member, a core having a circular cross-section and being formed inside the cladding, and a diffusion section, in which a part of the dopant is mixed with the second material, being formed inside the core. The cooling step is the step in which the second structure is cooled.

A method for producing a multimode graded-index plastic optical fiber of the present invention comprises steps of making a first member, making a second member, making a cylindrical combination member, making a preform and drawing the preform. In the step of making the first member, the first member which consists of a first material and has a circular cross-section is made. The first material includes a transparent first polymer and a dopant which is a nonpolymerizable substance having a refractive index higher than that of the first polymer. In the step of making the second member, the second member which consists of a second material and has a circular tube cross-section is made. The second member has an inside diameter which is no less than an outside diameter of the first member. The second material includes a transparent second polymer which has a refractive index lower than that of the first polymer. In the step of making the cylindrical combination member, the cylindrical combination member is made by inserting the first member into a cavity of the second member. In the step of making the preform, the preform is made by heating the combination member so that the dopant is diffused. In the step of drawing the preform, the preform is melted after the heating and drawn in a longitudinal direction.

According to the multimode graded-index plastic optical fiber of the present invention, the sufficient transmission capacity can be developed even if the g-value is out of the optimum value calculated from the theoretical value, and the sufficient transmission capacity can be insured even if the optical fiber is used for different wavelengths. According to the method for producing the multimode graded-index plastic optical fiber of the present invention, the multimode graded-index plastic optical fiber having above-described benefits can be produced.

### BRIEF DESCRIPTION OF THE DRAWINGS

The above and other subjects and advantages of the present invention will become apparent from the following detailed description of the preferred embodiments when read in association with the accompanying drawings:

FIG. 1 is an explanatory drawing of an optical fiber of the present invention, wherein FIG. 1A is a cross-sectional view perpendicular to a longitudinal direction of the optical fiber, and FIG. 1B is a graph of a refractive index along a dashed line C of FIG. 1A;

FIG. 2 is a graph representing a relationship between light intensity of the optical fiber of the present invention and a light entrance position normalized to a radius of a core, wherein the solid line represents scattering light intensity, and the dashed line represents transmitted light intensity;

FIG. 3 is a graph representing a relationship between the light intensity of the optical fiber of the present invention and an order of a propagation mode group, wherein the solid line represents the scattering light intensity, and the dashed line represents the transmitted light intensity;

FIG. 4 is a graph representing a relationship between a bandwidth of an optical fiber and a refractive index profile parameter g, wherein the solid line represents theoretically-calculated values, black dots () represent data of the optical fibers of the present invention, and crosses (x) represent data of optical fibers of comparative experiments;

FIG. 5 is an explanatory drawing of a measurement method for scattering light intensity;

FIG. 6 is an explanatory drawing of a measurement method for transmitted light intensity;

FIG. 7 is a schematic drawing of an optical fiber producing apparatus;

FIG. 8 is an explanatory drawing of a relationship between a first structure and the optical fiber, wherein FIG. 8A is a side-view of the first structure, FIG. 8B is a cross-sectional view along (b)-(b) line in FIG. 8A, FIG. 8C is a graph of a refractive index along an alternate long and short dash line C in FIG. 8B, FIG. 8D is a graph of a refractive index along an alternate long and short dash line C in FIG. 8E, and FIG. 8E is a cross-sectional view perpendicular to the longitudinal direction of the optical fiber;

FIG. 9 is an explanatory drawing of a relationship between the first structure and the optical fiber, wherein FIG. 9A is a side-view of the first structure, FIG. 9B is a cross-sectional view along (b)-(b) line in FIG. 9A, FIG. 9C is a graph of a refractive index along an alternate long and short dash line C in FIG. 9B, FIG. 9D is a graph of a refractive index along an alternate long and short dash line C in FIG. 9E, and FIG. 9E is a cross-sectional view perpendicular to the longitudinal direction of the optical fiber;

FIG. 10 is an explanatory drawing of an optical fiber of the present invention, wherein FIG. 10A is a cross-sectional view perpendicular to a longitudinal direction of the optical fiber, and FIG. 10B is a graph of a refractive index along a dashed line C of FIG. 10A;

FIG. 11 is an explanatory drawing of a producing method for a preform;

FIG. 12 is a schematic drawing of a preform drawing equipment;

FIG. 13 is a graph representing a relationship between a bandwidth of an optical fiber and a refractive index profile parameter g, wherein the solid line represents theoretically-calculated values, and the black dot () represents the datum of the optical fiber of the present invention;

FIG. 14 is a graph representing a relationship between light intensity of an optical fiber of a comparative experiment and a light entrance position normalized to a radius of a core, wherein the solid line represents scattering light intensity, and the dashed line represents transmitted light intensity; and

FIG. 15 is a graph representing a relationship between the light intensity of the optical fiber of the comparative experiment and an order of a propagation mode group, wherein the solid line represents the scattering light intensity, and the dashed line represents the transmitted light intensity.

### DETAILED DESCRIPTION OF THE PREFERRED EMBODIMENTS

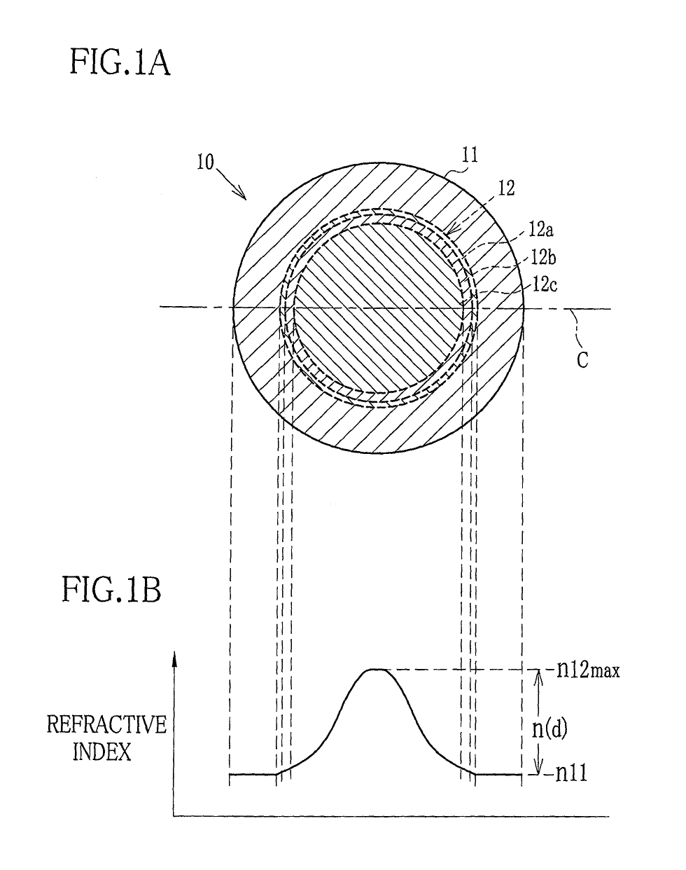

As illustrated in FIG. 1A, a multimode graded-index plastic optical fiber (hereinafter simply called as the optical fiber) 10 of the present invention has a circular cross-section on a plane which is perpendicular to a longitudinal direction.

The optical fiber 10 comprises a cladding 11 and a core 12 . The cladding 11 is provided around a periphery of the core 12 to cover the core 12 having a circular cross-section, and constitutes an outer shell of the optical fiber 10. As described above, the cladding 11 has a tube form whose cross-section on a plane which is perpendicular to a longitudinal direction is circular.

The cladding 11 has outer and inside diameters which are constant in the longitudinal direction, and a thickness which is also constant in the longitudinal direction. The inside diameter of the cladding 11 is equal to an outer diameter of the core 12. The outer diameter of the cladding 11 is not limited to a specific value. Although the inside diameter of the cladding 11 and the outer diameter of the core 12 are not limited, these are in a range of 50 μm to 750 μm in this embodiment.

An alternate long and short dash line C in FIG. 1A is a straight line which passes the center of the circular cross-section of the optical fiber 10 and extends in a radial direction of the optical fiber 10. FIG. 1B is a graph of a refractive index along the straight line C. In FIG. 1B, a horizontal axis represents the radial direction of the optical fiber 10, and a vertical axis represents the refractive index. As the vertical axis, the refractive index becomes higher as a position on the vertical axis becomes higher. The cladding 11 has the refractive index no more than the refractive index of the core 12. Accordingly, the optical fiber 10 having the circular cross-section transmits light entered from an end face (one end face) into the other end face with deflecting the light to be reflected at an interface between the cladding 11 and the core 12, and the light is emitted from the other end face.

In FIG. 1A, for the convenience of explanation, a borderline between the cladding 11 and the core 12 is illustrated. However, in practice, the borderline cannot be visually confirmed, and means a position where the refractive index from the periphery to the center of the circular cross-section starts an increase from a uniform value which the cladding has. In following explanations, the optical borderline between the cladding and the core is called as the optical core/cladding interface, and the cladding 11 and the core 12 in the present invention respectively mean an optical cladding and an optical core.

The refractive index of the core 12, as illustrated in FIG. 1B, continuously becomes higher from the optical core/cladding interface to the center of the circular cross-section, and the highest at the center. That is, in the core 12, the refractive index gradually becomes lower as becomes closer to the periphery. According to such the refractive index profile, the core 12 propagates light entered from the one end face, and the light is emitted from the other end face. Note that the refractive index profile and so on determine a dispersion property of mode dispersion of the optical fiber 10.

Since the refractive index of the cladding 11, as described above, is no more than the refractive index of the core 12, it is equal to or less than the minimum value of the refractive index of the core 12 which is continuously varies along the radial direction X.

In the radial direction X, a difference n(d) between the maximum value N12 max of the refractive index of the core 12 and the refractive index N11 of the cladding 11 is preferably in a range of 0.005 to 0.05, and is more preferably in a range of 0.015 to 0.025.

The refractive index of the cladding 11 is constant along the radial direction.

Although the variation of the refractive index of the core 12 is continuous along the radial direction as described above, the core 12 has a first core section 12a, a second core section 12b and a third core section 12c as areas having optical functions.

The third core section 12c has a circular cross-section which is perpendicular to the longitudinal direction, and is positioned at the center of the cross-section of the optical fiber 10. The second core section 12b is on the periphery of the third core section 12c so as to cover the third core section 12c. Accordingly, an inside diameter of the second core section 12b is equal to an outer diameter of the third core section 12c. The first core section 12a is on the periphery of the second core section 12b so as to cover the second core section 12b. Accordingly, an inside diameter of the first core section 12a is equal to an outer diameter of the second core section 12b. In this embodiment, each cross-section of the second core section 12b and the first core section 12a has a ring shape.

In the first core section 12a, the refractive index continuously becomes lower as being closer to the cladding 11, and the end point of this continuity is a borderline with the cladding 12. In case a graph of the refractive index along the radial direction is illustrated as FIG. 1B, about a curve represents the refractive index in the first core section 12a, its inclination is continuously varied and this continuity disappears at the borderline with the cladding 11. Accordingly, the first core section 12a develops the optical core/cladding interface.

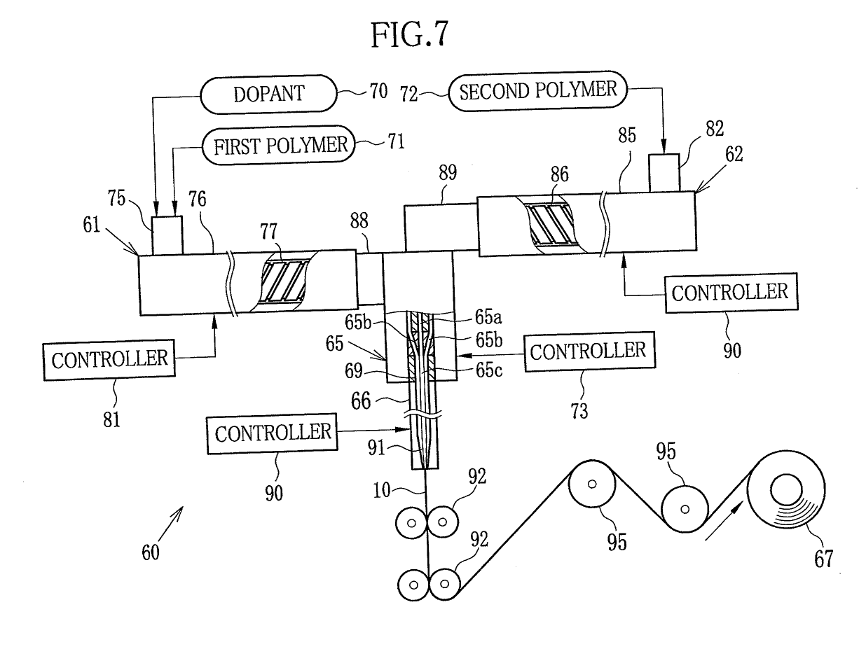

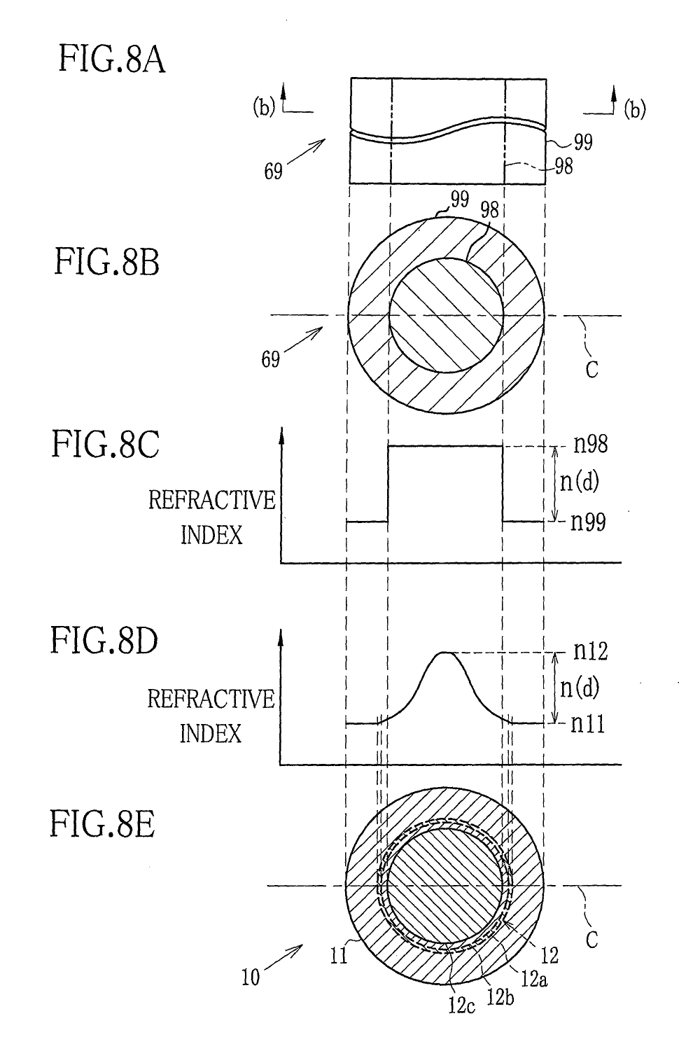

The second core section 12b scatters a part of light entered from the one end surface of the core 12. Note that in FIG. 1 and later-described FIG. 8, the second core section 12b is illustrated such that whose thickness is exaggerated against the radius of the core 12. The actual second core section 12b constitutes a borderline between a first polymer (see FIG. 7) which is a matrix component of the core and a second polymer (see FIG. 7) which is a material of the cladding. According to an analysis based on the scattering theory of Debye, it is found that there is a refractive index nonuniform structure of tens to 100 nm order in the second core section 12b. This nonuniform structure causes light scattering which is described later. Note that the scattering theory of Debye is disclosed in Debye, P.; Bueche, A. M. J. Appl. Phys. 1949, 20, 518.

In addition, in this embodiment, there is the second core section 12b inside the first core section 12a. However, there may be a case that a range of the second core section 12b becomes broaden so that the periphery of the second core section 12b becomes the periphery of the core 12 and the existence of the first core section 12a becomes indefinite. In this case, the second core section 12b has also the above-described function of the first core section 12a. But it is most preferable that there is the second core section 12b inside the first core section 12a, as this embodiment.

Under a condition that the radius of core 12 is represented as R, the second core section 12b is preferably in a range of 0.50xR to 0.98xR apart from the center of the cross-section of the core 12, that is, the periphery of the second core section 12b is preferably in a range of 0.50xR to 0.98xR apart from the center of the cross-section of the core 12. The second core section 12b is more preferably in a range of 0.70xR to 0.98xR, especially in a range of 0.80xR to 0.97xR apart from the center of the cross-section of the core 12.

In the third core section 12c, a difference between the maximum value and the minimum value of the refractive index is extremely larger than that in the first core section 12a and the second core section 12b. However, in the third core section 12c, as same as in the first core section 12a and the second core section 12b, the refractive index continuously becomes lower as becomes closer to the periphery. Accordingly, the third core section 12c largely contributes to develop light propagate performance of the optical fiber 10 as the GI plastic optical fiber.

It is preferable that the first core section, the second core section 12b and the third core section 12c are concentrically superimposed, and a cross-sectional center of a cavity of the second core section 12b is superimposed on the center of the circular cross-section of the core 12. According to that, a mode of scattering light as described below can be specified more certainly.

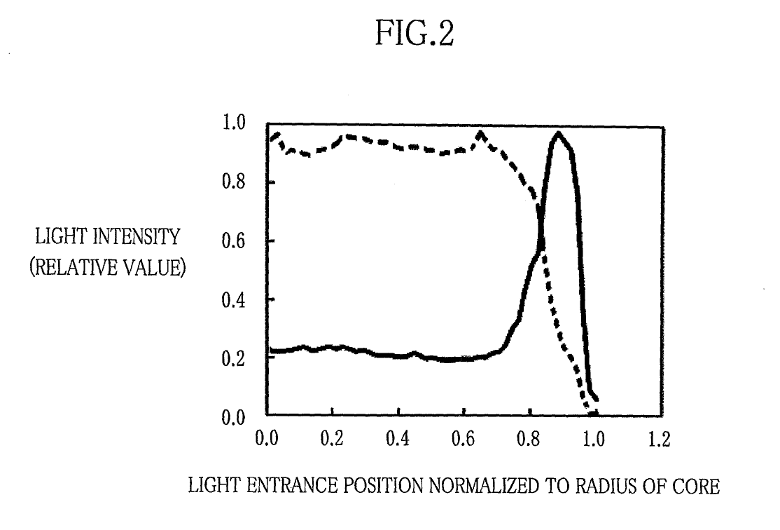

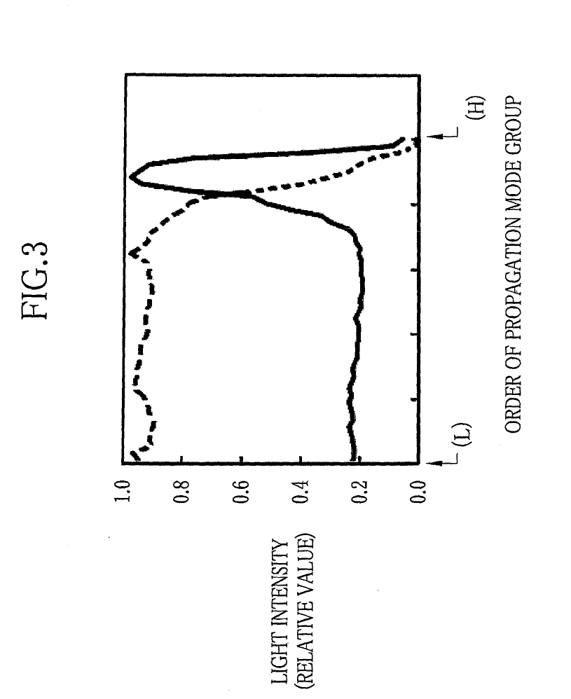

About the core 12 will be further explained with reference to FIG. 2 and FIG. 3. When light enters the one end face of the core 12, most of the entered light is emitted from the other end face, and a part of the entered light is emitted from a side face of the optical fiber 10. FIG. 2 and FIG. 3 are graphs respectively illustrating a relationship between a scattering light intensity and a transmitted light intensity of the optical fiber 10. The scattering light intensity is an intensity of scattering light, and is illustrated in FIG. 2 and FIG. 3 as solid lines. The scattering light is light emitted from the side face of the optical fiber 10 when the light is entered into the one end face of the core 12. The transmitted light intensity is an intensity of transmitted light, and is illustrated in FIG. 2 and FIG. 3 as dashed lines. The transmitted light is light emitted from the other end face of the optical fiber 10 when the light is entered into the one end face of the core 12. Measurement methods for the scattering light intensity and the transmitted light intensity are described later with reference to other figures.

In FIG. 2, a horizontal axis represents a light entrance position normalized to the radius of the core 12. The maximum value of the light entrance position is 1. In case of the GI optical fiber, the value of the light entrance position corresponds to an order of a propagation mode group. Concretely, the light entrance position whose value is closer to 0 corresponds to a mode group with a lower order, and the light entrance position whose value is closer to 1 corresponds to a mode group with a higher order. According to this correspondence, a horizontal axis represents an order of the propagation mode group in FIG. 3. In addition, a vertical axis in each of FIG. 2 and FIG. 3 represents normalized light intensity. Note that the light intensity is relative value normalized to the maximum value in measurement of respective light intensity. Accordingly, the maximum value of the light intensity is 1.

As illustrated in FIG. 2, the scattering light intensity is about 0.2 when the light entrance position is in a range of 0 to about 0.7. When the light entrance position is in a range of about 0.7 to about 0.9, as the value of the light entrance position becomes larger, the scattering light intensity becomes larger, and becomes the largest at the light entrance position of about 0.9. When the light entrance position is in a range of about 0.9 to about 0.97, as the value of the light entrance position becomes larger, the scattering light intensity becomes smaller, and reaches less than 0.1. When the light entrance position is in a range of about 0.97 to 1, the scattering light intensity becomes smaller and reaches close to 0. The light scattering intensity becomes greatly high at the light entrance position of close to 0.9, and exceeds 0.9.

On the contrary, the transmitted light intensity is no less than 0.7 when the light entrance position is in a range of 0 to about 0.8. When the light entrance position is in a range of about 0.8 to about 0.97, as the value of the light entrance position becomes larger, the transmitted light intensity becomes smaller, and reaches less than 0.1. When the light entrance position is in a range of about 0.97 to 1, the transmitted light intensity becomes smaller and reaches close to 0. Note that when the light entrance position is in a range of 0 to about 0.85, the transmitted light intensity is greatly higher than the scattering light intensity, and when the light entrance position is in a range of about 0.85 to 1, the scattering light intensity is greatly higher than the transmitted light intensity.

The scattering light intensity and the transmitted light intensity are as described below in relation to an order of the propagation mode group. About the horizontal axis in FIG. 3, the left end illustrated as an arrow (L) represents light of the lowest order mode in the propagation mode group, and the right end illustrated as an arrow (H) represents light of the highest order mode in the propagation mode group. About such the scattering light intensity and the order of the propagation mode group, light of a lower order mode has low scattering light intensity, and light of a higher order mode has greatly high scattering light intensity. That is, the optical fiber 10 hardly scatters light of the first mode whose order is relatively low, but scatters light of the second mode whose order is relatively high.

A mode group whose order is relatively low largely contributes to information transmission of high-speed in propagation of light from the one end face to the other end face of the core 12, but a mode group whose order is relatively high causes degradation of the bandwidth of the optical fiber 10 so that the high-speed transmission is interfered. In the present invention, from a perspective of degree of contribution for information transmission in such mode group, the light of the lower order mode group is surely propagated. In addition, the light of the higher order mode group is scattered inside the core 12 to be attenuated so that the intensity of the light of the higher order mode group becomes sufficiently low against the propagating intensity of the light of the lower order mode group.

In the core 12, each of the first core section 12a to the third core section 12c is a propagating section for propagating the light of the first mode which should be propagated. In addition, the second core section 12b is a light scattering section for scattering the light of the second mode toward outside the optical fiber 10. Accordingly, the second core section 12b has both functions of propagating the light of the first mode and of scattering the light of the second mode.

Note that there is a case that there are a plurality of light of first modes which should be propagated, that is, there is a plurality of light, which should be propagated whose order of mode are different from each other, as a mode group. In such the case, in the optical fiber 10, a scattering loss rate calculated according to (SLN/SL0)×100 is preferably at least 150%, more preferably at least 200%, especially preferably at least 500%. SL0 is the scattering loss of the light of the mode whose order is the lowest in the first mode group, that is, the lowest order mode. SLN is the maximum value of the scattering loss of the light of the second mode group. Note that in case there is a plurality of the lowest order modes, SL0 is determined as the scattering loss of the light of the lowest order mode group including these lowest order modes.

In FIG. 3, the scattering loss SL0 of the light of the lowest order mode is the scattering light intensity at the left end of the horizontal axis. In addition, the maximum value SLN of the scattering loss of the light of the second mode group is the scattering light intensity at the light entrance position of about 0.9 in FIG. 2, and is the scattering light intensity at the order along the horizontal axis in FIG. 3, which corresponds to the above-described light entrance position in FIG. 2. SL0 of the optical fiber 10 illustrated in FIG. 3 is about 0.22, and SLN is about 0.98. The scattering loss rate of the optical fiber 10 calculated from these values is 445%.

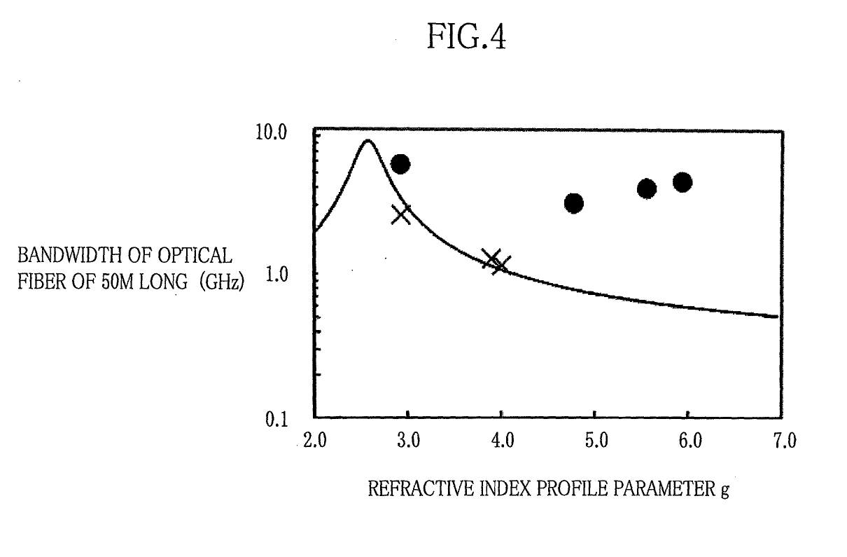

About a refractive index profile parameter g of the optical fiber 10 will be explained below with reference to FIG. 4. In FIG. 4, a horizontal axis represents the refractive index profile parameter g, and a vertical axis represents a bandwidth (unit; GHz) of the optical fiber 10 of 50 m long. The bandwidth of the optical fiber 10 of 50 m long becomes a reference of transmission capacity of the optical fiber. The bandwidth of the optical fiber 10 of 50 m long can be theoretically found by calculation about a case that light of specific wavelength is entered. In FIG. 4, g calculated by this theory about a case that light of 850 nm wavelength is entered is illustrated as a solid line.

g-value of the optical fiber 10 is illustrated as black dots () in FIG. 4. Optimum g-value which is theoretically calculated is about 2.7 in FIG. 4, and a bandwidth corresponding to this g-value is about 8.5 GHz. As illustrated in FIG. 4, about the optical fiber 10, whose bandwidth is not largely lowered at each of g-values of about 3, about 4.8, about 5.6 and about 5.9 which are off from 2.7. In addition, against a conventional optical fiber whose bandwidth becomes lower as a difference between its g-value and optimum g-value becomes larger, the bandwidth of the optical fiber 10 does not become lower even if the difference from its g-value and 2.7 becomes larger. As described above, the optical fiber 10 of the present invention has the broad bandwidth, and keeps sufficient transmission capacity even if its g-value becomes off from the optimum g-value which is theoretically calculated.

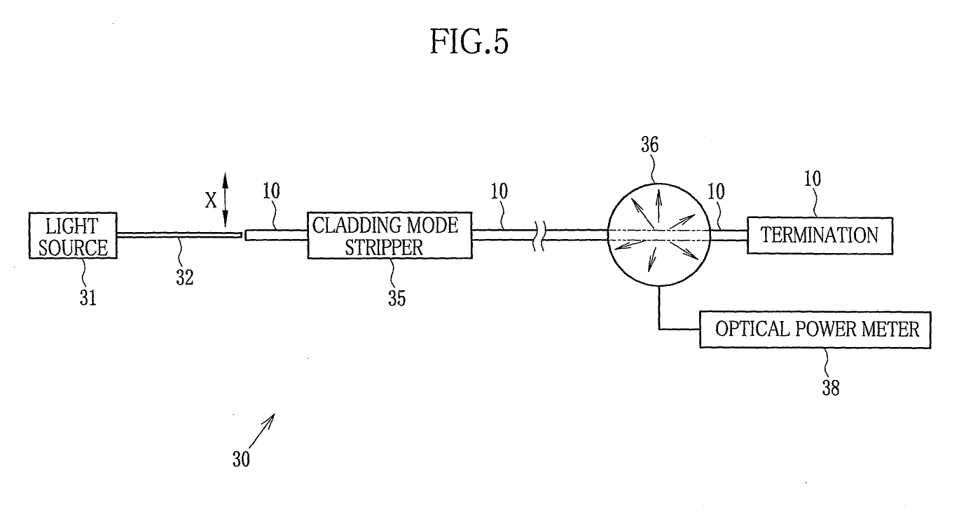

About a measurement method for the scattering light intensity which is described above will be explained with reference to FIG. 5. A scattering light intensity measuring device 30 comprises a light source 31, a single-mode optical fiber (hereinafter called as SMF) 32, a cladding mode stripper 35, an integrating sphere 36 and a termination 37 in this order from an upstream side of a traveling direction of light from the light source 31, and further comprises an optical power meter 38 to be connected to the integrating sphere 36.

As the light source 31, a laser diode is used. One end face of SMF 32 is connected to the light source 31. When light from the light source 31 is entered into the one end face, the SMF 32 propagates the incoming light in its longitudinal direction and emits the light from the other end face.

The optical fiber 10 is set such that its one end face is faced to the other end face of SMF 32. Accordingly, the light emitted from the SMF 32 enters the one end face of the optical fiber 10. The SMF 32 is supported by a supporting member (not illustrated), and the supporting member has a shifting mechanism (not illustrated). The shifting mechanism controls the supporting member to displace the SMF so that the other end face of the SMF 32 facing the optical fiber 10 is displaced in the radial direction X of the optical fiber 10. According to this displacement, an entrance position at the optical fiber 10 for the light emitted from the SMF 32 is regulated. By this regulation, the light entrance position is controlled for the measurement of the scattering light intensity. Note that although the SMF 32 is displaced in this embodiment, the present invention is not limited to this embodiment. For example, it may be changed to an embodiment that the SMF 32 stands and the optical fiber 10 is displaced in the radial direction X, or it may be that both the SMF 32 and the optical fiber 10 are displaced so that a relative position between the end faces of the SMF 32 and the optical fiber 10 facing each other is changed in the radial direction X of the optical fiber 10.

Each of the cladding mode stripper 35, the integrating sphere 36 and the termination 37 has a support (not illustrated) to support the optical fiber 10 which is an object to be measured.

The cladding mode stripper 35 strips a mode component of the propagated inside the cladding 11, when the light from the light source is entered into the set optical fiber 10. Accordingly, about the incoming light to the optical fiber 10, only light of a mode bound inside the core 12 is propagated.

The integrating sphere 36 is a sphere whose inside is a cavity. On the integrating sphere 36, two openings to which the optical fiber 10 is inserted are formed. When the scattering light is emitted from the side face of the optical fiber 10 toward various directions, the scattering light is subject to a multiple diffuse reflection at an inside wall of the integrating sphere 36. By this diffuse reflection, intensity of the scattering light is averaged.

The integrating sphere 36 comprises a photo detecting section (not illustrated) for detecting light intensity. When the scattering light is subject to the diffuse reflection at the inside wall of the integrating sphere 36, the photo detecting section detects the diffuse-reflected light and sends a detected signal to the optical power meter 38. The optical power meter 38 outputs the signal sent from the photo detecting section of the integrating sphere 36, as the light intensity. The output light intensity as described above is detected as the scattering light intensity.

In the termination 37 which connects the integrating sphere 36, index-matching fluid (not illustrated) is filled. The other end face of the optical fiber 10 is set in the index-matching fluid of the termination 37. The index-matching fluid cancels influence of light returned after reflected at the other end face of the optical fiber 10 (reflected-return light at the other end face).

The light entrance position by the SMF 32 is varied about the radial direction X of the optical fiber 10, and the scattering light intensity is detected at each light entrance position. Accordingly, the scattering light intensity is measured.

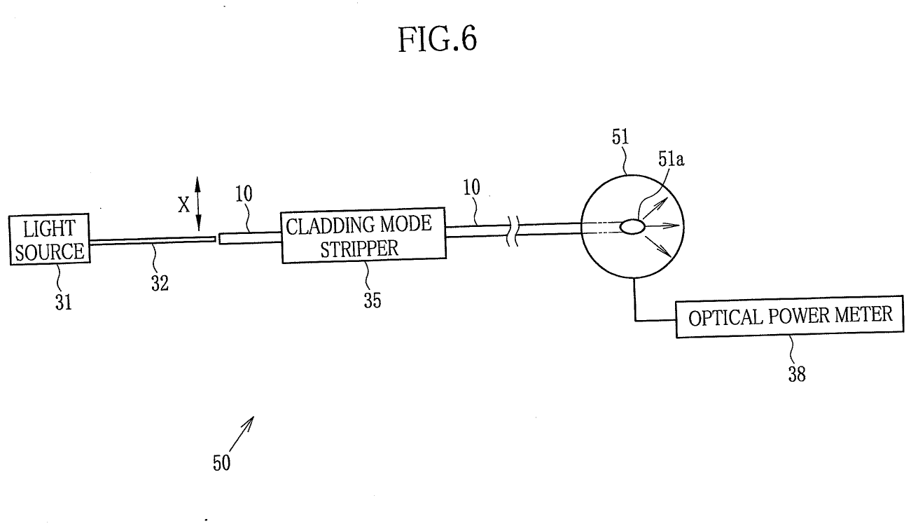

Next, a measurement method for the transmitted light intensity will be explained with reference to FIG. 6. About a transmitted light intensity measuring device 50 in FIG. 6, same reference numbers are applied to the members same as in the scattering light intensity measuring device 30 in FIG. 5, and their explanations are abbreviated.

The transmitted light intensity measuring device 50 comprises the light source 31, the SMF 32, the cladding mode stripper 35, and an integrating sphere 51 in this order from the upstream side of the traveling direction of light from the light source 31, and further comprises the optical power meter 38 to be connected to the integrating sphere 51.

A termination 51a is provided inside the integrating sphere 51, and the index-matching fluid is filled in the termination 51a. The other end of the optical fiber 10 is set in the index-matching fluid of the termination 51a.

On the integrating sphere 51, an opening to which the optical fiber 10 is inserted is formed. When the transmitted light is emitted from the other end face of the optical fiber 10, the transmitted light is subject to the diffuse reflection at an inside wall of the integrating sphere 36. By the diffuse reflection, intensity of the transmitted light is averaged.

The integrating sphere 51 comprises a photo detecting section (not illustrated) for detecting light intensity. When the transmitted light is subject to the diffuse reflection at the inside wall of the integrating sphere 51, the photo detecting section detects the diffuse-reflected light and sends a detected signal to the optical power meter 38. The optical power meter 38 outputs the signal sent from the photo detecting section of the integrating sphere 36, as the light intensity. The output light intensity as described above is detected as the transmitted light intensity.

The light entrance position by the SMF 32 is varied about the radial direction X of the optical fiber 10, and the transmitted light intensity is detected at each light entrance position. Accordingly, the transmitted light intensity is measured.

Producing methods for the optical fiber 10 will be explained. The optical fiber 10 can be produced by each of a method utilizing a melt-extrusion method and a method utilizing a method called as a rod-in-tube method.

The producing method utilizing the melt-extrusion method will be explained. An optical fiber producing apparatus 60 in FIG. 7 comprises a first extrusion equipment 61, a second extrusion equipment 62, a co-extrusion equipment 65, a diffusion equipment 66 and a winding equipment 67.

The first extrusion equipment 61 heats a fed dopant 70 and a first polymer 71 to melt the first polymer 71 and guides it toward a downstream side. The second extrusion equipment 62 heats a fed second polymer 72 to melt it and guides it toward a downstream side. The co-extrusion equipment 65 guides the first polymer 71 and the second polymer 72 from the first extrusion equipment 61 and the second extrusion equipment 62 toward a downstream side such that the second polymer 72 covers around the first polymer 71. The diffusion equipment 66 heats a first structure 69 in which the second polymer 72 covers the first polymer 71 to diffuse the dopant 70, and then gradually cools it. The winding equipment 67 winds the optical fiber 10 guided from the diffusion equipment 66. Each of the equipments will be explained below in detail.

The first extrusion equipment 61 comprises a hopper 75 and an extruder 76. The hopper 75 is provided on an upper part in an upstream side of the extruder 76. The hopper 75 guides the dopant 70 and the first polymer 71 toward the extruder 76, when the dopant 70 and the first polymer 71 are fed into the hopper 75.

The extruder 76 comprises a screw 77, a heater (not illustrated), and a controller 81 to control the heater.

The heater is controlled its heating value by the controller 81, and by this control an inside temperature of the extruder 76 is controlled. With control of the inside temperature of the extruder 76, the guided first polymer 71 is heated to be melted.

The screw 77 extends in a longitudinal direction of the extruder 76. The screw 77 has a drive means, and is rotated in a circumferential direction by the drive means. By this rotation, melting of the first polymer 71 effectively progresses, and the first polymer 71 and the dopant 70 are mixed while being guided toward a downstream side.

The second extrusion equipment 62 comprises a hopper 82 and an extruder 85. The hopper 82 is provided on an upper part in an upstream side of the extruder 85. The hopper 82 guides the second polymer 72 toward the extruder 85, when the second polymer 72 is fed into the hopper 82.

The extruder 85 comprises a screw 86, a heater (not illustrated), and a controller to control the heater.

Configurations of the heater, the controller 87 and the screw 86 are same as in the first extrusion equipment 61 and their explanations are abbreviated. With control of the inside temperature of the extruder 85, the guided second polymer 72 is heated to be melted. By this rotation of the screw 86, melting of the second polymer 72 effectively progresses, and the second polymer 72 is guided toward a downstream side.

On downstream ends of the first extrusion equipment 61 and the second extrusion equipment 62, connecting members 88 and 89 which are connected to the co-extrusion equipment 65 are respectively provided. The connecting members 88 and 89 respectively have a heater (not illustrated) and a controller (not illustrated) to control the heater. A first material which is a mixture of the dopant 70 and the first polymer 71 is guided toward the co-extrusion equipment 65 through the connecting member 88 with keeping a melting state. In addition, the second polymer 72 as a second material is guided toward the co-extrusion equipment 65 through the connecting member 89 with keeping a melting state.

Inside the co-extrusion equipment 65, a first flow channel 65a which carries the first material to have a circular cross-section, and a second flow channel 65b which joins the first flow channel 65a so as to carries the second material around a periphery of the first material are formed. In a downstream section from a joint position where the first flow channel 65a and the second flow channel 65b are joined, a common flow channel 65c, which guides both the first material and the second material toward a downstream side such that the second material covers the periphery of the first material, is formed.

The co-extrusion equipment 65 comprises a heater (not illustrated) and a controller 73 which controls the heater. By the controller 73, heating value of the heater is controlled to regulate temperatures of the first material flowing inside the first flow channel 65a, the second material flowing inside the second flow channel 65b, and the first and second materials flowing inside the common flow channel 65c.

The co-extrusion equipment 65 forms the first structure 69 where the second material covers the periphery of the first material, and guides the ¥ first structure 69 toward the diffusion equipment 66. Note that the first structure 69 to be guided to the diffusion equipment 66 may be in a state of once being solidified by cooling, or may be kept in a state of being melted. However, in this embodiment, the first structure 69 with being remained in the melting state is guided to the diffusion equipment 66.

The diffusion equipment 66 is connected to a downstream end of the co-extrusion equipment 65. The diffusion equipment 66 comprises a plurality of heaters (not illustrated) and a controller 90. The heaters are arranged in a longitudinal direction of the diffusion equipment 66. The first structure 69 is heated by the heater so that the dopant is diffused. The controller 90 controls each heating value of the each heater. According to this control, a diffusion rate of the dopant 70 in the first structure 69 is controlled, and the first structure 69 becomes a second structure 91 where the second core section 12b is formed.

Inside the diffusion equipment 66, the first structure 69 is heated such that the temperature rising goes on or the temperature is raised to a predetermined value and the value is kept, in the diffusion area where the diffusion of the dopant 70 is progressed. A downstream section from the diffusion area, the temperature of the heater is controlled so that the temperature of the second structure 91 is gradually decreased.

Note that a length, the inside temperature, and a pulling speed of the diffusion equipment 66 can be appropriately changed to change the g-value of the optical fiber 10. About the pulling speed will be explained later.

A downstream side from the diffusion equipment 66, a roller pair 92 and a roller 95 are provided. The roller pair 92 comprises a drive means (not illustrated), by which the optical fiber 10 is drawn from the upstream side along the longitudinal direction. The draw speed of the optical fiber 10 in the drawing as described above is the above-described pulling speed. The drive means comprises a controller (not illustrated) which controls a rotation speed of the roller pair 92 so as to control a tension given to the second structure 91 or to the optical fiber 10. According to this control, a tension of the first structure 69 in the longitudinal direction in the co-extrusion equipment 65, and tensions of the first structure 69 and the second structure 70 in the longitudinal direction in the diffusion equipment 66 are regulated. According to this regulation, the diameter of the optical fiber 10 is controlled.

The winding equipment 67 rotates a winding section which is set, to wind the optical fiber 10 which is guided.

Structures and refractive indexes of the first structure 69 and the optical fiber 10 will be explained with reference to FIG. 8. Note that FIG. 8C and FIG. 8D illustrates a case where the refractive indexes of the first polymer 71 (see FIG. 7) and the second polymer 72 (see FIG. 7) are equal to each other.

An alternate long and short dash line C in FIG. 8B is a straight line, which passes the center of the circular cross-section of the first structure 69 and extends in a radial direction of the first structure 69. FIG. 8C is a graph of the refractive index along the straight line C of FIG. 8B. The first structure 69 is, as illustrated in FIGS. 8A and 8B, constituted of a first member 98 formed of the first material and a second member 99 formed of the second material. The first material includes the first polymer and the dopant 70 (see FIG. 7) . Accordingly, the refractive index of the first member 98 is higher than the refractive index of the second member 99, as including the dopant 70. That is, a difference n(d) calculated by subtracting the refractive index n99 of the second member 99 from the refractive index n98 of the first member 98 is caused by the dopant 70.

When the dopant 70 is diffused by the diffusion equipment 66, although most of the dopant 70 remains in the first member 98, a part of the dopant 70 moves to the second member 99. In addition, distribution of the dopant 70 along the radial direction X of the first member 98 becomes the highest at the center of the circular cross-section, and gradually reduces as going to the periphery.

An alternate long and short dash line C in FIG. 8E is a straight line, which passes the center of the circular cross-section of the optical fiber 10 and extends in the radial direction of the optical fiber 10. FIG. 8D is a graph of the refractive index along the straight line C of FIG. 8E. About the optical fiber 10 finally obtained by the above-described diffusion, as illustrated in FIG. 8D, the refractive index becomes the highest at the center of the core, and gradually reduces as going to the periphery. Then the optical fiber 10, as illustrated in FIG. 8E and FIG. 1A, becomes to have the cladding 11 and the core 12 which develop the optical core/cladding interface, and have a structure of the core 12 where the first core section 12a, the second core section 12b and the third core section 12c having optical functions are superimposed in this order from the periphery to the center. Note that in this embodiment, an interface between the second core section 12b and the third core section 12c corresponds to an interface between the first member 98 and the second member 99 of the first structure 69. That means that the second core section 12b is formed at the second member 99 side, and that the optical core/cladding interface is formed in the second member 99.

Note that an outer diameter of the first structure 69 illustrated in FIGS. 8A and 8B and an outer diameter of the optical fiber 10 illustrated in FIG. 8E are not coincide with each other. When the first structure 69 is drawn in the longitudinal direction, the outer diameter of the optical fiber 10 becomes smaller than the outer diameter of the first structure 69. Accordingly, FIGS. 8A and 8B, and 8E illustrate a correspondence relationship that each optical member in FIG. 8E comes from what member in FIG. 8A and FIG. 8B.

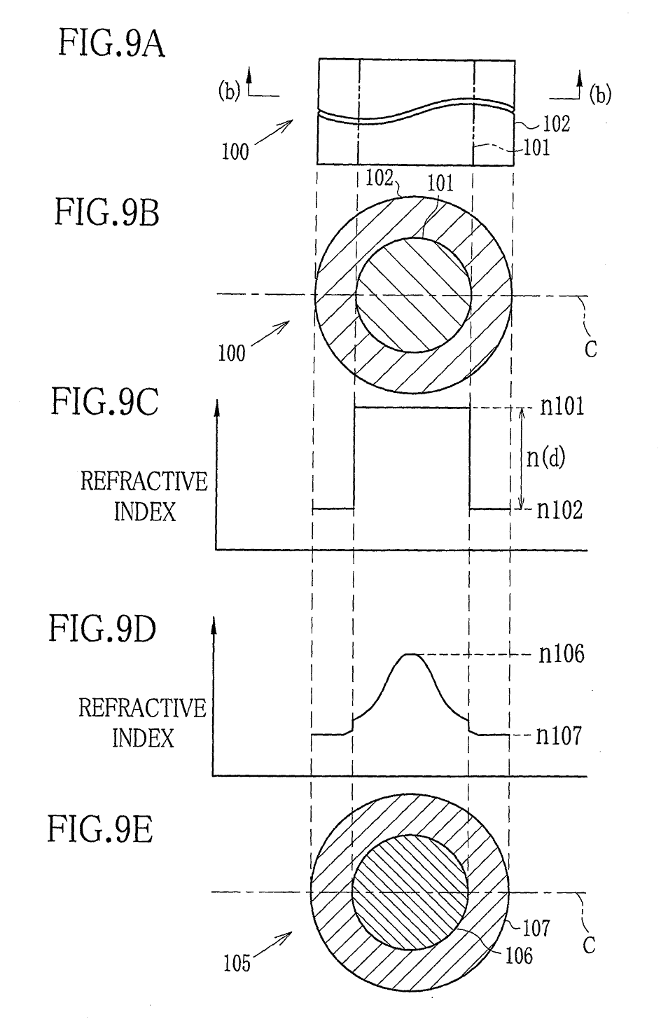

A case, that the refractive index of first polymer 71 becomes higher than the refractive index of the second polymer 72 and a difference between them becomes large, will be explained with reference to FIG. 9. An alternate long and short dash line C in FIG. 9B is a straight line, which passes a center of a circular cross-section of a first structure 100 and extends in a radial direction of the first structure 100. FIG. 9C is a graph of the refractive index along the straight line C of FIG. 9B. A first member 101 of the first structure 100 illustrated in FIGS. 9A and 9B, as illustrated in FIG. 9C, is formed with use of the first polymer whose refractive index is larger than the second polymer which forms a second member 102. Since the first member 101 is formed with including the dopant, whose refractive index difference n(d) from the second member 102 is greatly larger than that of the first member 98 illustrated in FIG. 8.

An alternate long and short dash line C in FIG. 9E is a straight line, which passes a center of a circular cross-section of an optical fiber 105 and extends in a radial direction of the optical fiber 105. FIG. 9D is a graph of the refractive index along the straight line C of FIG. 9E. About the first structure 100, when the dopant is diffused, there causes a large difference between a maximum value of a refractive index of an area of the optical fiber 105 obtained from the first member 101 and a minimum value of a refractive index of an area obtained from the second member 102. Accordingly, when a graph of a refractive index profile along the redial direction X like FIG. 9D is illustrated, curves representing the obtained area from the first member 101 and the obtained area from the second member 102 are not continuous from each other. In such the case, the optical core/cladding interface corresponds to a borderline between the obtained area from the first member 101 and the obtained area from the second member 102. Accordingly, inside such the core, the second core section as the scattering layer is not formed. The obtained optical fiber 105 is constituted from a core 106 formed of the first member 101 and a cladding 107 formed of the second member 102.

Therefore, in the present invention, it is preferable that the first member 98 and the second member 99 are formed of the first polymer 71 and the second polymer 72 whose refractive indexes are same to each other. However, in case the difference of the refractive indexes between the first polymer 71 and the second polymer 72 is small, and when a graph of a refractive index profile along the redial direction is illustrated, curves of the refractive indexes of the core and the cladding become continuous and inclinations of then become continuous from each other by the diffusion of the dopant 70, there may be a difference of the refractive indexes of the first polymer 71 and the second polymer 72. The reason is that the second core section as the diffusion layer is formed inside the obtained core.

As described above, since the optical core/cladding interface is formed in the second member 99, the first member 98 is not limited the one formed of one kind of the first material. That is, a plurality of first materials may be provided, and a first member having a multilayered structure may be formed by concentrically superimposing these plural first materials. In addition, since the optical core/cladding interface is formed by the diffusion of the dopant 70, also the second member 99 may be changed to the multilayered structure as the first member.

The refractive index profile of the optical fiber of the present invention is not limited to the optical fiber 10 illustrated in FIG. 1. For example, an optical fiber 110 having a refractive index profile described below may be. As described above, each of the optical fiber 10 and the optical fiber 110 can be selected by appropriately changing the length of the diffusion equipment 66, the inside temperature of the diffusion equipment 66 and the pulling speed.

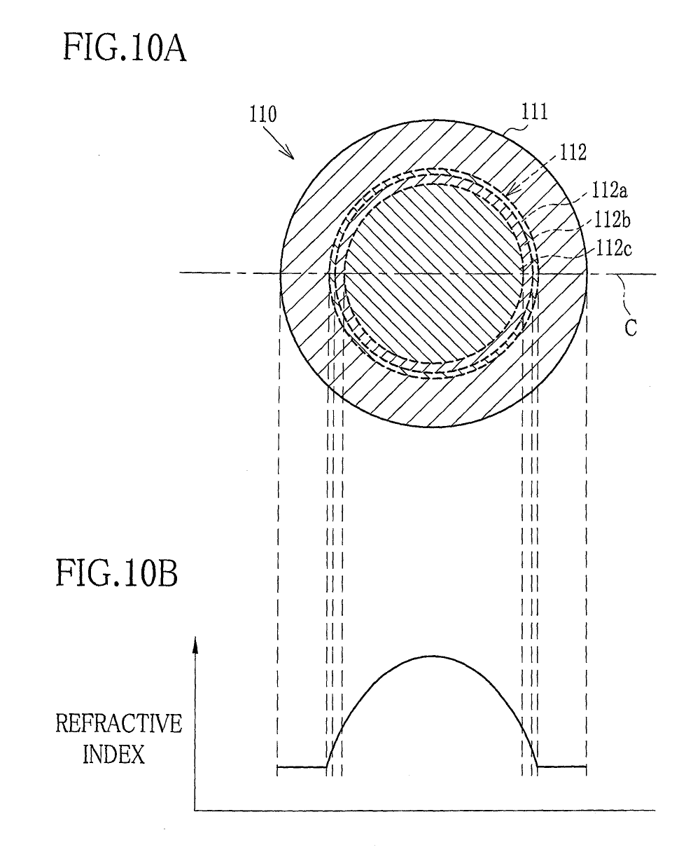

An alternate long and short dash line C in FIG. 10A is a straight line, which passes a center of a circular cross-section of the optical fiber 110 and extends in a radial direction of the optical fiber 110. FIG. 10B is a graph of the refractive index along the straight line C of FIG. 10A. The optical fiber 110 in FIG. 10 comprises a cladding 111 and a core 112 which develop the core/cladding interface, as same as the optical fiber 10 (see FIG. 10A). The core 112 has a first core section 112a, a second core section 112b and a third core section 112c, as same as the core of the optical fiber 10.

As illustrated in FIG. 10B, in the core 112 of the optical fiber 110, an inclination of the graph of the refractive index from the optical core/cladding interface, that is, an initial rise, is larger than that in the optical fiber 10. And the inclination of the graph gradually becomes smaller as going toward the center of the radial direction.

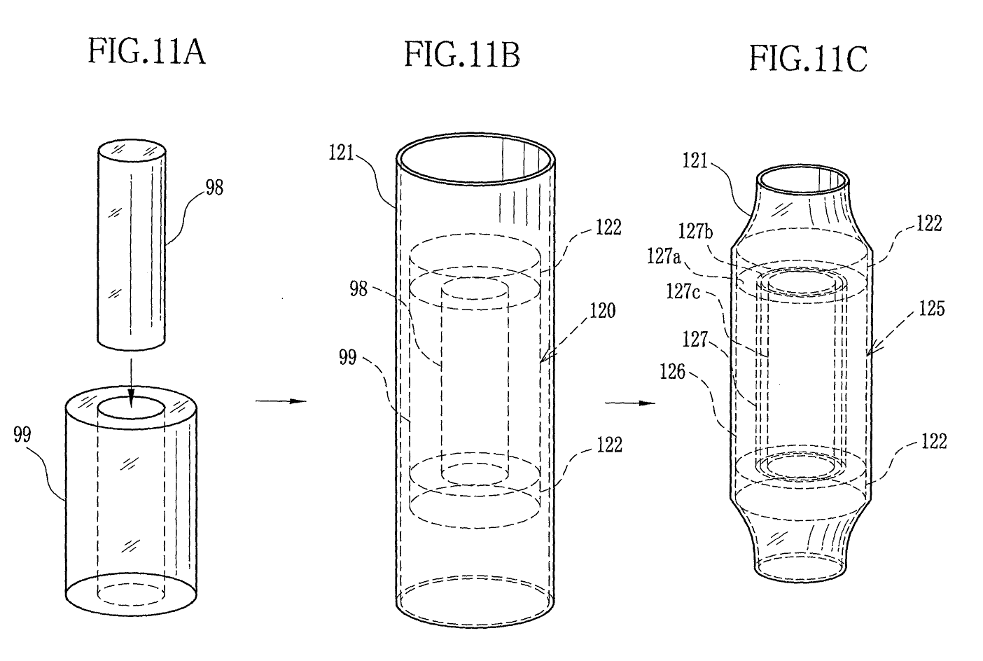

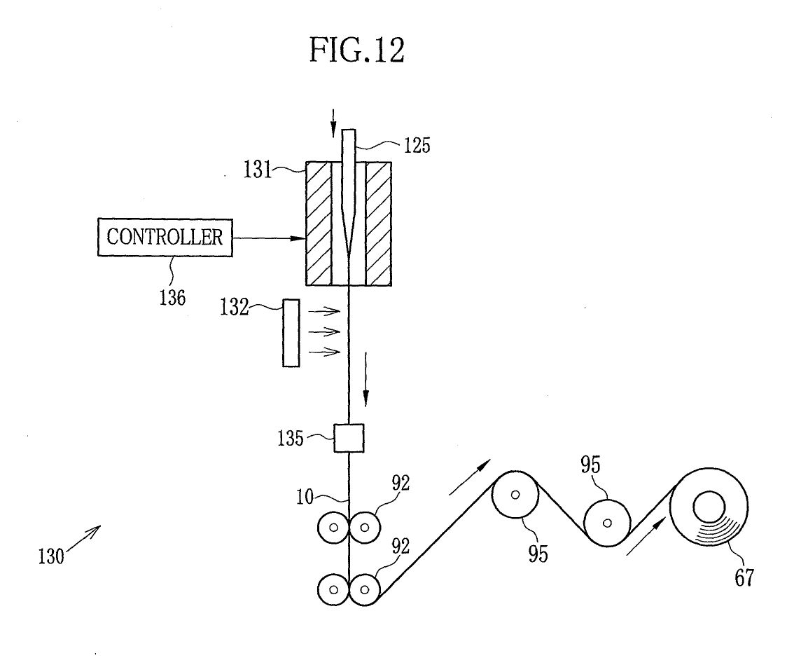

Furthermore, the optical fiber 10 can be produced by a following method as illustrated in FIG. 11 and FIG. 12. This method utilizes the rod-in-tube method. At first, the first member 98 having a circular cross-section is made by melting the first material. In addition, the second member 99 having a circular tube cross-section is made by melting the second material. The second member 99 is made to have an inside diameter which is larger than an outside diameter of the first member 98. Next, as illustrated in FIG. 11A, the first member 98 is inserted into a cavity of the second member 99. Accordingly, a cylindrical combination member 120 is made.

As a method for producing the second member 99, there is a following method. At first, a glass tube whose one end is sealed is prepared, and the glass tube is washed with water. The washed glass tube is further rinsed in ultrapure water and then it is dried. A mixed solution of the monomer for generating the second polymer 72 and a polymerization assistant is subject to prepolymerization in a water bath. As the polymerization assistant, there are a polymerization initiator, a chain transfer agent and so on. In this embodiment, the second polymer 72 and the first polymer 71 are the same substance. After this prepolymerization, the monomer mixed solution which becomes in a sol state with high viscosity is poured into the glass tube. The glass tube after pouring is fixed to a bearing. The glass tube is rotated for polymerization under high temperature atmosphere, at a speed of about 2000 rpm to 3000 rpm by a motor connected to the glass tube through a spacer made of a flexible rubber tube. Accordingly, the second member 99 is formed inside the glass tube. Finally, the end of the glass tube is broken and the second member 00 is pulled out.

As a method for producing the first member 98, there is a following method. A core monomer mixed solution of the dopant 70, a polymerization assistant and a monomer for generating the first polymer 71 is subject to polymerization. As the polymerization assistant, there are the polymerization initiator, the chain transfer agent and so on. A composition of the core monomer mixed solution, and polymerization conditions are determined such that a molecular weight of each of the first polymer 71 and the second polymer 72 becomes a same level. A glass ampoule tube is prepared, and the ampoule tube is rinsed with water. After the rinse, the ampoule tube is washed with acetone whose impurities are removed by filtration. The core monomer mixed solution is poured into the ampoule tube, and a freeze-degassing process is repeated until air in the monomer mixed solution sufficiently comes out. After that, the ampoule tube in the degassed state is subject to vacuum sealing by heating its opening section with use of a gas burner. Since this is subject to polymerization in an oil bath of high temperature, the first member 98 is formed in the ampoule tube. The ampoule tube is broken and the first member 98 is pulled out.

The produced first member 98 and the second member 99 are washed with ultrapure water and then they are sufficiently dried.

Next, a heat-shrinkable tube 121 having a tubular body, which shrinks by application of heat, is prepared. The heat-shrinkable tube 121 is washed with ultrapure water and then it is sufficiently dried. In a cavity of the heat-shrinkable tube 121, the combination member 120 is contained. A cylindrical holding members 122 is provided at each of both sides of the combination member 120, for preventing that the dopant 70 (see FIG. 7), the first polymer 71 and the second polymer 72 which are melted by heating described later come out of the heat-shrinkable tube 121. As the holding member 122, one that is made of Teflon (a registered trademark) is preferable. The holding member 122 is washed with ultrapure water and then it is sufficiently dried before it is used. A graph of a refractive index profile of the combination member 120 is the same as FIG. 8C.

The heat-shrinkable tube 121 in a state of containing the combination member 120 and the holding member 122 is heated. The heating is performed by putting the tube 121 into an oven whose inside is set to a predetermined temperature. When putting the tube 121 into the oven, for preventing that the combination member 120 comes out the heat-shrinkable tube 121, it is preferable that heat is preliminarily applied to the both ends of the heat-shrinkable tube 121 so as to shrink them. The heating is performed such that the dopant 70 in the first member 98 is diffused. That is, a temperature and a retention time of the temperature of the combination member 120 in heating are set so as to diffuse the dopant 70. In this embodiment, the heat-shrinkable tube 121 in the state of containing the combination member 120 and the holding member 122 is put into the oven in 120° C. Then the heat-shrinkable tube 121 is subject to the temperature rising at a speed of 10° C./h until the temperature reaches a value in a range of 160° C. to 170° C. After that, the tube 121 stands 24 to 48 hours with keeping the temperature to accelerate the form of the GI distribution. After the temperature keeping, the heat-shrinkable tube 121 is subject to temperature descending. While the temperature descending, for preventing a detachment between the first member 98 and the second member 99 and an occurrence of a void, the temperature descending speed is kept slow, for example at 10° C./h. Accordingly, a preform 125 of GI type is formed in the heat-shrinkable tube 121.

According to the above-described heating, the first member 98 and the second member 99 of the combination member 120 are subject to thermal welding. In this heating, as illustrated in FIG. 11C, since the heat-shrinkable tube 121 shrinks, the first member 98 and the second member 99 press each other for the preferable thermal welding without the occurrence of the void or the like. By this heating, the combination member 120 becomes the preform 125 in which the dopant 70 is diffused. The heat-shrinkable tube 121 is removed to obtain the preform 125 of GI type.

The obtained preform 125 has a refractive index profile of GI type like FIG. 8D and FIG. 10B, comprises an optical cladding 126 and a core 127, and the core 127 has a second area 127b which becomes the second core section 12b after the drawing. Accordingly, the second area 127b performs light scattering and is formed in the second member 99. The core 127 contacts an inner circumference of the cladding 126, and has a first area 127a which becomes the first core section 12a after the drawing, and a third area 127c positioned on the inner circumference of the light scattering section 126a.

Next, the obtained preform 125 is melt to be soften by being heated to a temperature in a range of about 180° C. to 245° C., and is drawn in the longitudinal direction to be the optical fiber 10. In FIG. 12, the same reference numbers are applied to the members same as those in FIG. 7, and the explanations for them are abbreviated. As illustrated in FIG. 12, a preform drawing equipment 130 comprises a heating section 131, a cooling section 132, an outer diameter measurement section 135, the roller pair 92 and the roller 95 in this order from an upstream side, and is connected to the winding equipment 67.

Inside the heating section 136, a passage through which the preform 125 passes is formed. The heating section 136 has a controller 136 to control an inside temperature. The controller 136 controls the guided preform 125 to a predetermined temperature.

The cooling section 132 positioned at a downstream side from the heating section 136 is an air blow means for sending air of a predetermined temperature toward a leading edge of the preform which came out the heating section 131. According to cooling by the air blow, the optical fiber 10 is obtained.

The roller pair 92 positioned at the downstream side from the heating section 136 pulls the optical fiber 10 at a predetermined pulling speed at the downstream side from the heating section 136. In the pulling, the pulling speed is controlled by the outer diameter measurement section 135, which detects the outer diameter of the optical fiber 10 so that the rotation speed of the roller pair 92 is regulated based on the detection result. Accordingly, the optical fiber 10 having a predetermined outer diameter can be produced.

The dopant 70, the first polymer 71 and the second polymer 72 will be explained below.

The dopant 70 is a low molecular weight material which has a higher refractive index than that of the first polymer 71. The low molecular weight material is preferably a compound, more preferably a monomer. As the dopant 70, one which has no property of reactive to the first polymer 71, that is, so-called unreactive, is used.

The first polymer 71 is a matrix component of the first member 98, and is an organic polymer which is transparent. The matrix means the component which is the form of the first member 98 and should transmits light.

The second polymer 72 is an organic polymer which forms the second member 99 and is transparent. For example, poly(methylmethacrylate) (PMMA), poly(ethyl methacrylate), poly(phenyl methacrylate), poly(butyl methacrylate), poly(2,2,2-trifluoroethyl methacrylate), polystyrene, poly(vinylidene fluoride), perfluoro Butenyl Vinyl Ether and so on can be listed.

[Example]

Next, an example of the present invention will be explained. As the explanation of each experiment, about Experiment 1 is explained in detail, and about Experiment 2 and Comparative experiment, explanations of conditions same as that in Experiment 1 are abbreviated.

<Experiment 1>

The optical fiber 10 was produced with use of the preform producing method illustrated in FIG. 11 and the preform drawing equipment 130 in FIG. 12.

Diphenyl sulfone (DPS) was used as the dopant 70, and PMMA was used as the first polymer 71. The first material was one in which a mass of the DPS was 20 when a mass of the PMMA was 100, that is, the one in which the DPS was 20 mass %. As the second polymer 72, PMMA was used. Only the second polymer was the second material.

By the second polymer 72, the second member 99 of a hollow shape was produced. The produced first member 98, the second member 99, the heat-shrinkable tube 121 and the holding member 122 were washed with ultrapure water and then they were sufficiently dried. As illustrated in FIG. 11, the first member 98 was inserted into the second member 99, and they were contained in the heat-shrinkable tube 121. For preventing that the first polymer 71 and the second polymer 72, which became the melting state, came out the heat-shrinkable tube 121, the both ends of the inside of the heat-shrinkable tube 121 were closed by the holding members 122.

The heat-shrinkable tube 121 containing the first member 98 and the second member 99 was put in the oven in 120° C., then was subject to the temperature rising at the speed of 10° C./h until the temperature reaches a value in a range of 160° C. to 170° C. After that, the tube 121 stood 48 hours with keeping the temperature to accelerate the form of the GI distribution. As described above, the first member 98 and the second member 99 were subject to the contact bonding in the melting state and held for a long time. Accordingly, the diffusion of the dopant 70 was accelerated to develop the GI refractive index profile. While the temperature descending, for preventing the detachment between the first member 98 and the second member 99 and the occurrence of a void, the temperature descending speed was kept slow, at 10° C./h. The heat-shrinkable tube was removed and the preform 125 having the GI refractive index profile was obtained.

The produced preform was soften by being heated to a temperature in the range about 180° C. to 245° C., and drawn to produce the optical fiber 10 having the GI refractive index profile.

(Evaluation of Transmission Property)

About the obtained optical fiber 10, a relationship between the g-value and the bandwidth of the light having the wavelength of 850 nm was calculated. The calculated result was illustrated as the black dot (574 ) in FIG. 4. Note that in FIG. 4, the bandwidth theoretically calculated from the each g-value was additionally illustrated as the solid line.

(Evaluation of Optical Property)

About the obtained optical fiber 10, the scattering light intensity and the transmitted light intensity in relation to the light entrance position were calculated, and the scattering light intensity and the transmitted light intensity in relation to the order of the propagation mode group were calculated. The calculated results were illustrated in FIG. 2 and FIG. 3.

<Experiment 2>

With use of the optical fiber producing apparatus illustrated in FIG. 7, the optical fiber 10 was produced. As the first extrusion equipment 61 and the second extrusion equipment 62, the ones comprising the screws 77 and 78 of 16 mm diameter were used.

Under the condition that the first material and the second material were the melting resin, the temperatures of the first material and the second material by the first extrusion equipment 61 and the second extrusion equipment 62, and the temperatures of the first material and the second material by the first flow channel 65a and the second flow channel 65b of the co-extrusion equipment 65 were respectively controlled such that the temperature of the first material became 210° C. and that of the second material became 230° C. at the join position in the co-extrusion equipment 65.

As the diffusion equipment 66, the one having the inside diameter of φ20 mm and the length of 90 cm was used. At the downstream end of the diffusion equipment 66, a dies (not illustrated) having an inside diameter of φ1 mm was preliminary provided. The inside temperature of the diffusion equipment 66 was controlled to 190° C. at the upstream side, and to cool the second structure 91 at the downstream side so that the second structure 91 as the optical fiber 10 came out the dies. The optical fiber 10 pushed out of the dies was pulled at a speed of 5 m/min by the roller pair 92 which rotated at a slow speed.

(Evaluation of Transmission Property)

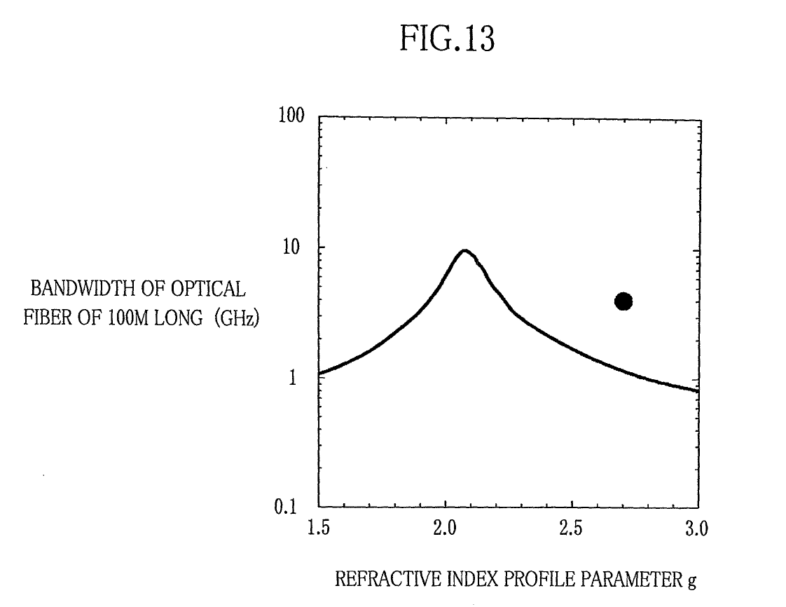

About the obtained optical fiber 10, a relationship between the g-value and the bandwidth of the light having the wavelength of 850 nm was calculated. The calculated result was illustrated as the black dot () in FIG. 13. Note that in FIG. 13, the bandwidth theoretically calculated from the each g-value was additionally illustrated as the solid line.

<Comparative Experiment 1>

By the interfacial gel polymerization method, the preform was made, and then the optical fiber was produced from the preform.

(Making of Preform)

Inside the glass tubular container whose inside diameter was 22 mm, methyl methacrylate (MMA) of 100g, polymerization initiator of 0.5 weight % and chain transfer agent of 0.28 weight % were filled, and then the opening of the tubular container was sealed. The tubular container was put in a water tank as a constant-temperature tank for about two hours so that the raw material filled in the container became the sol state. In this period, a temperature of the water tank was kept in 70° C. The tubular container was held by the holder section provided in the water tank, and the polymerization of the MMA was performed while the tubular container was rotated by the holder section in the circumferential direction at about 2000 rpm for three hours, so that a tube constituted of the PMMA having 60 cm length was obtained. In this period, the water temperature was kept in 70° C.

Next, the tubular container of glass was removed from the obtained tube of the PMMA. The tube was vertically soaked in the oil bath whose temperature was set at 90° C. The mixture liquid constituting the MMA, the DPS, whose quantity was corresponding to a condition that the refractive index difference against the PMMA became 0.015, and the polymerization assistant was filtrated by the membrane filter and poured into the cavity of the tube. After that, the tube which was held by a jig was contained in an autoclave as the polymerization equipment. An inside temperature of the autoclave was set to 120° C. The inside air of the autoclave was substituted by nitrogen, and the polymerization reaction of the MMA was performed for about 48 hours under pressure of 120° C., so that the preform in which the refractive index was continuously varied along the radial direction was produced.

(Production of Optical Fiber)

The obtained preform was subject to the heat-drawing in 235° C. by the drawing apparatus, so that the GI optical fiber whose outer diameter was 0.75 mm was obtained.

(Evaluation)

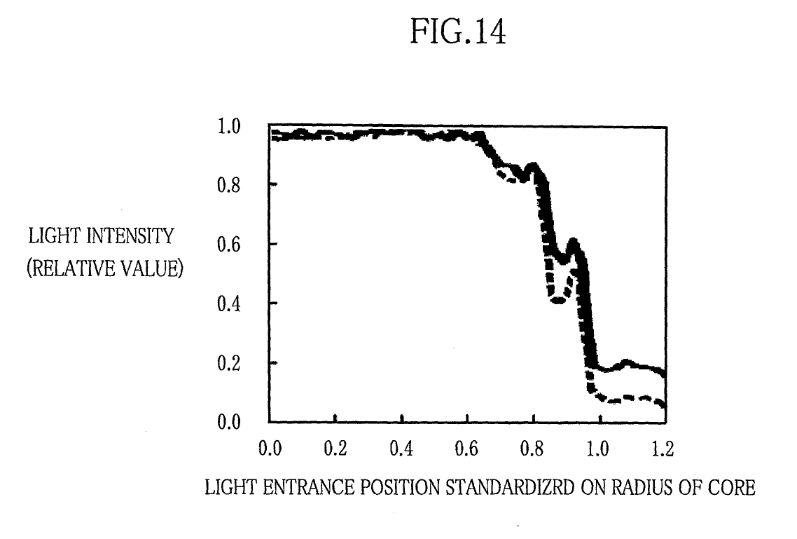

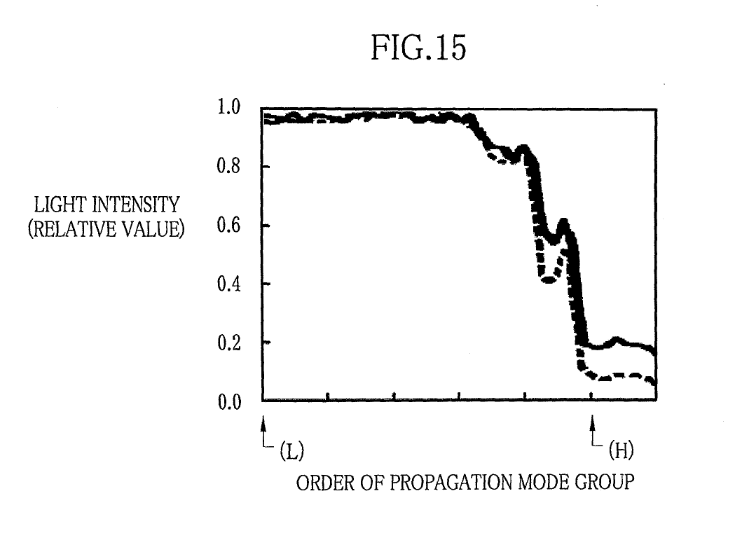

About the obtained optical fiber, the transmission property and the optical property were evaluated by the method same as that in Experiment 1. The result of the obtained transmission property was illustrated as a cross (x) in FIG. 4. In addition, the evaluation of the optical property was illustrated in FIG. 14 and FIG. 15.

Various changes and modifications of the present invention will be apparent to those having skill in this field. Therefore, unless otherwise these changes and modifications depart from the scope of the present invention, they should be construed as included therein.

What is claimed is:

1. A multimode graded-index plastic optical fiber comprising:
a core whose refractive index continuously becomes higher as closer to a center of a circular cross-section of said core, said core propagating light of a first mode group, which should be propagated, of incoming light from one end face of said core and emitting said light from the other end face of said core;
a cladding which is provided on a periphery of said core and has a cylindrical cross-section, said cladding having a refractive index which is lower than that of said core and deflecting light of said first mode group at an interface with said core; and
a light scattering section which scatters light of a second mode group of said incoming light outside, said second mode group being of a higher order than said first mode group, and said light scattering section being inside said core.

2. A multimode graded-index plastic optical fiber claimed in claim 1, wherein said light scattering section has a ring cross-section, and wherein a center of a circular cross-section of a cavity is superimposed on the center of the circular cross-section of said core.

3. A multimode graded-index plastic optical fiber claimed in claim 1, wherein a scattering loss rate calculated according to (SLN/SL0)x100 is at least 150%, under conditions that SL0 is a scattering loss of light of a mode whose order is the lowest in said first mode group, and that SLN is the maximum value of a scattering loss of light of said second mode group.

4. A multimode graded-index plastic optical fiber claimed in claim 2, wherein a scattering loss rate calculated according to (SLN/SL0)x100 is at least 150%, under conditions that SL0 is a scattering loss of light of a mode whose order is the lowest in said first mode group, and that SLN is the maximum value of a scattering loss of light of said second mode group.

5. A multimode graded-index plastic optical fiber claimed in claim 1, wherein said light scattering section is positioned in a range of 0.50xR to 0.98xR apart from the center of the circular cross-section of said core, under a condition that a radius of said core is represented as R.

6. A multimode graded-index plastic optical fiber claimed in claim 2, wherein said light scattering section is positioned in a range of 0.50xR to 0.98xR apart from the center of the circular cross-section of said core, under a condition that a radius of said core is represented as R.

7. A multimode graded-index plastic optical fiber claimed in claim 3, wherein said light scattering section is positioned in a range of 0.50xR to 0.98xR apart from the center of the circular cross-section of said core, under a condition that a radius of said core is represented as R.

8. A multimode graded-index plastic optical fiber claimed in claim 4, wherein said light scattering section is positioned in a range of 0.50xR to 0.98xR apart from the center of the circular cross-section of said core, under a condition that a radius of said core is represented as R.

9. A method for producing a multimode graded-index plastic optical fiber comprising steps of:
forming a first structure in which a periphery of a first member having a circular cross-section is covered by a second member, said first member including a transparent first polymer and a dopant which is a nonpolymerizable substance having a refractive index higher than that of said first polymer, said second member including a transparent second polymer which has a refractive index lower than that of said first polymer;
diffusing said dopant by heating said first structure, said diffusion making said first structure to a second structure, said second structure including a cladding having a ring cross-section and consisting of a part including a periphery of said second member, a core having a circular cross-section and being formed inside said cladding, and a diffusion section, in which a part of said dopant is mixed with said second material, being formed inside said core; and
cooling said second structure.

10. A method for producing a multimode graded-index plastic optical fiber comprising steps of:
making a first member which consists of a first material and has a circular cross-section, said first material including a transparent first polymer and a dopant which is a nonpolymerizable substance having a refractive index higher than that of said first polymer;
making a second member which consists of a second material and has a circular tube cross-section, said second member having an inside diameter which is no less than an outside diameter of said first member, said second material including a transparent second polymer which has a refractive index lower than that of said first polymer;
making a cylindrical combination member by inserting said first member into a cavity of said second member;
making a preform by heating said combination member so that said dopant is diffused; and
melting said preform after said heating and drawing said preform in a longitudinal direction.
